(19) United States
(12) Patent Application Publication
(10) Pub. No.: US 2005/0241003 A1
(43) Pub. Date: Oct. 27, 2005

(54) Cellular telephone based electronic access control system

(76) Inventors: Kevin Sweeney, Andover, MA (US); Rainer Wischinski, Sandown, NH (US)

Correspondence Address: DEVINE, MILLIMET & BRANCH, P.A., 111 AMHERST STREET, BOX 719, MANCHESTER, NH, 03105, US

(21) Appl. No.: 11/115,959

(22) Filed: Apr. 27, 2005

Related U.S. Application Data
(60) Provisional application No. 60/565,664, filed on Apr. 27, 2004.

(51) Int. Cl. F02M 51/00

(52) U.S. Cl. 726/28

(57) ABSTRACT

A system and method for cellular telephone based electronic access control (EAC) of secured portals is depicted. The EAC system determines whether access to any particular secured portal is to be granted to a user based on the relative geographic positions of the secured portal and the user's cellular telephone. If the cellular telephone is within a configurable radius of the secured portal, the EAC system checks its database to determine whether the user of the cellular telephone has been granted access privileges to the secured portal. If the user has been granted access privileges, the EAC system electronically unlocks the secured portal.

### CROSS-REFERENCE TO RELATED APPLICATIONS

The present application claims the benefit of Provisional Application Ser. No. 60/565,664 filed Apr. 27, 2004, which is incorporated herein by reference.

### TECHNICAL FIELD

The present disclosure relates to electronic access control (EAC) systems for secured facilities and, in particular, to an EAC system based on the relative positions of a secured portal to which a user seeks access and the user's cellular telephone.

### BACKGROUND OF THE INVENTION

Electronic access control (EAC) has been used for many years. In typical EAC systems, a user is issued a physical token (usually a machine readable card) that is used by the EAC system to identify the user. When a user attempts to gain access to a secured facility through some type of secured portal (i.e. door, parking garage gate, fence gate, etc.) controlled by the EAC system, he presents the token to an appropriate token reader mounted near the secured portal. The EAC system verifies that the user has been granted the right permissions to enter the secured portal by consulting a database. It then electronically unlocks the secured portal if access should be granted.

In other systems, there is no physical token. For example, a biometric signature is used instead. In this case, an appropriate biometric reader at the secured portal is used to measure some unique aspect of the user attempting to gain access, such as a finger print, face print, or retinal pattern.

In each of these EAC systems, some type of credential reader hardware must be installed at the secured portal controlled by the system. This adds to the total cost of securing the portal due to additional hardware and labor costs at the portal. The cost of the EAC system is also increased because it requires additional circuitry and connectors to interface electrically with the credential reader at each portal that is part of the system. It is clear that an EAC system that does not require a physical credential reader at each portal will have cost advantages over an EAC system that does.

Accordingly, there is a need for an EAC system and method that eliminates the need to purchase and install expensive credential readers at each secured portal controlled by the EAC system.

### SUMMARY OF THE INVENTION

The present invention is a system and method for providing electronic access control (EAC) to one or more secured portals at one or more secured facilities. The EAC system of the present invention is based, in part, on the existence of a unique identifier, e.g. the telephone number, for every cellular telephone. It determines whether access to any particular secured portal is to be granted to a user based on the relative geographic positions of the portal and the user's cellular telephone.

The EAC system of one embodiment of the present invention enters into its database a unique identifier of the cellular telephone of each user who has been granted access privileges to one or more of the secured portals controlled by the EAC system. The EAC system also enters into its database the specific portals to which each user has been granted access privileges. The geographic position of each user's cellular telephone is then determined through the use of the Global Positioning Satellite (“GPS”) system for the cellular telephones that are GPS enabled. Each cellular telephone then transmits its identifier and geographic position to a GPS wireless service provider. The EAC system polls the GPS wireless service provider for the identifier and geographic position of each of the cellular telephones in the EAC system's database. Upon receiving updated position information for a cellular telephone showing it within a configurable radius of a secured portal, the EAC system checks its database to determine if the user of the cellular telephone has been granted access privileges to the secured portal. When the EAC system has verified the position of the cellular telephone and the grant of access privileges to the user of the cellular telephone, the EAC system then sends a signal to a control device, including but not limited to an electric door striker, that instructs the control device to open the secured portal.

Thus, the present invention provides an EAC system and method in which there is no need to purchase or install expensive credential reader hardware at each secured portal controlled by the EAC system.

Also, another embodiment of the EAC system and method of the present invention may contain additional security measures to provide an additional level of authentication before the EAC system opens a secured portal. These measures include, but are not limited to, requiring a user to enter a personal identification number (PIN) using his cellular telephone keypad, which PIN is then transmitted to the EAC system database. The EAC system then checks the PIN against information in its database identifying specific PINs that have been granted access privileges to a secured portal. Also, the EAC system can use biometric identification information provided by a biometric reader incorporated into a user's cellular telephone.

Additionally, another embodiment of the EAC system of the present invention electronically opens secured portals in the interior of a secured facility where GPS signals may be blocked or may be so attenuated as not to permit a GPS enabled cellular telephone to use the GPS system to determine its geographic position. This embodiment includes using a wireless transmitter, including but not limited to a low cost local radio or cellular transmitter, located at or near an internal secured portal, to transmit a unique portal identifier that can be received and retransmitted, along with the cellular telephone identifier, to the EAC system only by a cellular telephone within a configurable radius of the secured internal portal. The receipt of this information by the EAC system allows it to determine that the user's cellular telephone is within a configurable radius of the secured internal portal. The EAC system then checks its database to determine if the user of the cellular telephone has been granted access privileges to the secured internal portal.

These aspects of the present invention are not meant to be exclusive and other features, aspects, and advantages of the present invention will be readily apparent to those of ordinary skill in the art when read in conjunction with the following description, appended claims, and accompanying drawings.

### BRIEF DESCRIPTION OF THE DRAWINGS

These and other features and advantages of the present invention will be better understood by reading the following detailed description, taken together with the drawings wherein:

FIG. 1 is a flow chart of an embodiment of a GPS tracking system for tracking a GPS enabled cellular telephone.

FIG. 2 is a schematic diagram of an embodiment of a cellular telephone based access control system for an external portal.

FIG. 3 is a schematic diagram of an embodiment of a cellular telephone based access control system for an internal portal.

### DETAILED DESCRIPTION OF THE INVENTION

The Global Positioning Satellite (“GPS”) system was originally developed by the United States Department of Defense to enable a GPS receiver to determine its latitude and longitude, in other words its geographic position. The GPS system now includes 24 satellites that are in constant motion on six different paths above the earth.

The GPS system is now used for many civil applications, including locating and tracking vehicles. There are numerous commercially available services that track vehicles, such as armored cars and delivery vehicles, with GPS receivers. These services can also be used to track cellular telephones that are GPS enabled, in other words ones that include GPS receivers.

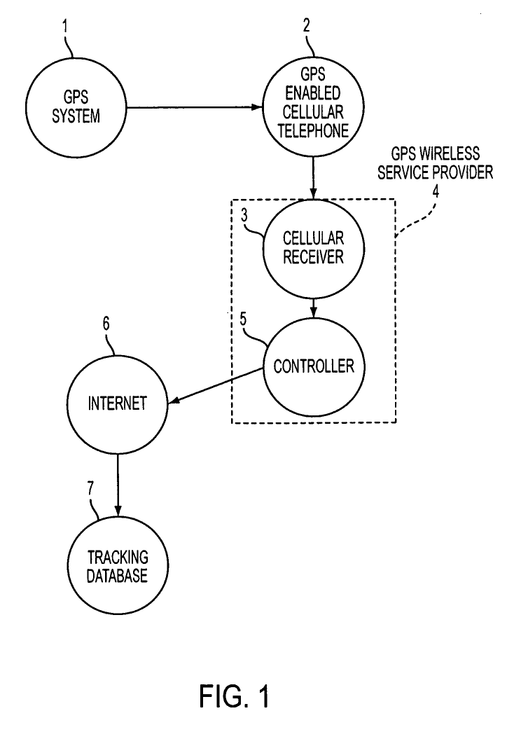

One embodiment of such services is shown in FIG. 1. The GPS system 1 sends signals containing precise time information to a GPS enabled cellular phone 2 enabling it to determine its geographic position. The GPS enabled cellular telephone 2 then wirelessly transmits its geographic position and a unique identifier, typically its telephone number, to a receiver 3 at the GPS wireless service provider 4, which relays the identifier and the geographic position to a controller 5. The identifier and position are then relayed on the internet 6 to the computer on which the tracking database 7 of the customer is maintained.

The GPS enabled cellular telephone 2 can be set to transmit its identifier and geographic position automatically at configurable intervals or only manually. Each such transmission is typically less than 60 bytes in size. In similar fashion, controller 15 can be set to relay the identifier and geographic position of the GPS enabled cellular telephone 2 automatically at configurable intervals or manually only when polled by the computer on which the tracking database 7 of the customer is maintained. Alternatively, in another embodiment of such services, the controller 5 wirelessly relays the identifier and geographic position of the GPS enabled cellular telephone to the tracking database 7 of the customer.

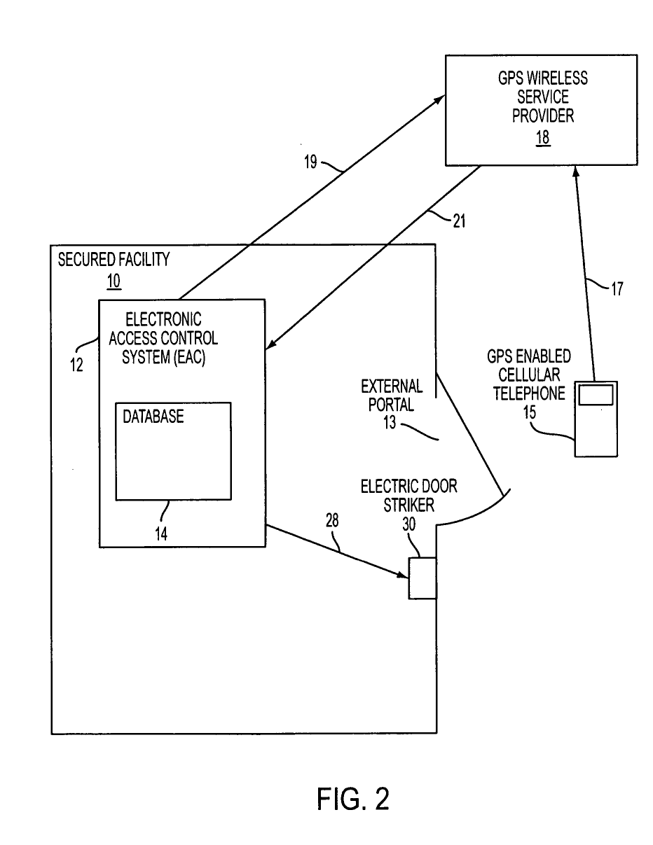

A preferred embodiment of both the system and method of the present invention, based on the above-described GPS tracking services, is shown in FIG. 2. A secured facility 10 is shown. Located within the secured facility 10 is an electronic access control (EAC) system 12. The EAC system 12 controls access by users to the secured facility 10 through one or more external secured portals 13.

The EAC system has a database 14 maintained on a computer that contains the geographic position of one or more secured external portal 13; the identity of one or more users granted access privileges to one or more secured external portals 13; and the particular secured portals 13 to which a user has been granted access privileges. The database 14 also contains a unique identifier, for example the telephone number, of a GPS enabled cellular telephone 15 for each user. A user is granted access through a secured external portal 13 based on the relative geographic positions of the secured external portal 13 and the user's GPS enabled cellular telephone 15, as described in more detail below.

The geographic position of each GPS enabled cellular telephone 15 is determined through the use of the GPS system. Other embodiments of the present invention may determine the geographic position of each cellular telephone through the use of cellular telephone tower triangulation, or through other means known to those skilled in the art. Each GPS enabled cellular telephone 15 provides its identifier and geographic position to a GPS wireless service provider 18. A GPS enabled cellular telephone 15 may be programmed automatically to provide its identifier and geographic position periodically or it may do so only manually. In the case of cell tower triangulation, the cellular telephone only provides its identifier, and its geographic position is determined by the cellular services provider.

The EAC system 12 then polls 19 the GPS wireless service provider 18 for the identifier and geographic position of each GPS enabled cellular telephone 15 in its database 14. The frequency of the polling can be configured to meet the needs of the EAC system based on a variety of factors including minimizing the number of messages between the EAC system 12 and the GPS wireless service provider 18. The GPS wireless service provider 18, then, relays 21 each cellular telephone's identifier and geographic position to the EAC system 12 over the Internet. The EAC system 12 then again polls 19 the GPS wireless service provider 18 for the identifier and position of each GPS enabled cellular telephone 15 that is within a configurable radius of the secured facility 10 at a faster configurable rate than those GPS enabled cellular telephones 15 that are farther away. Alternatively, the steps of polling the GPS wireless service provider 18 can be omitted, and the GPS wireless service provider 18 can be programmed automatically to provide periodically the identifier and geographic position of each GPS enabled cellular telephone 15. The EAC system 12, then, verifies whether a GPS enabled cellular telephone 15 is within a configurable radius of a secured external portal 13 at the secured facility 10. If such a secured external portal is found, the computer on which the EAC system's database 14 is stored examines the database 14 to determine if the user to whom the GPS enabled cellular telephone 15 belongs has been granted access privileges to the secured external portal 13. When the computer of EAC system 12 has verified the identifier and geographic position of the GPS enabled cellular telephone 15 and the grant of access privileges to the secured external portal 13, the EAC system 12 then sends a command 28 to an electric door striker 30 that instructs the electric door striker 30 to open the secured external portal 13.

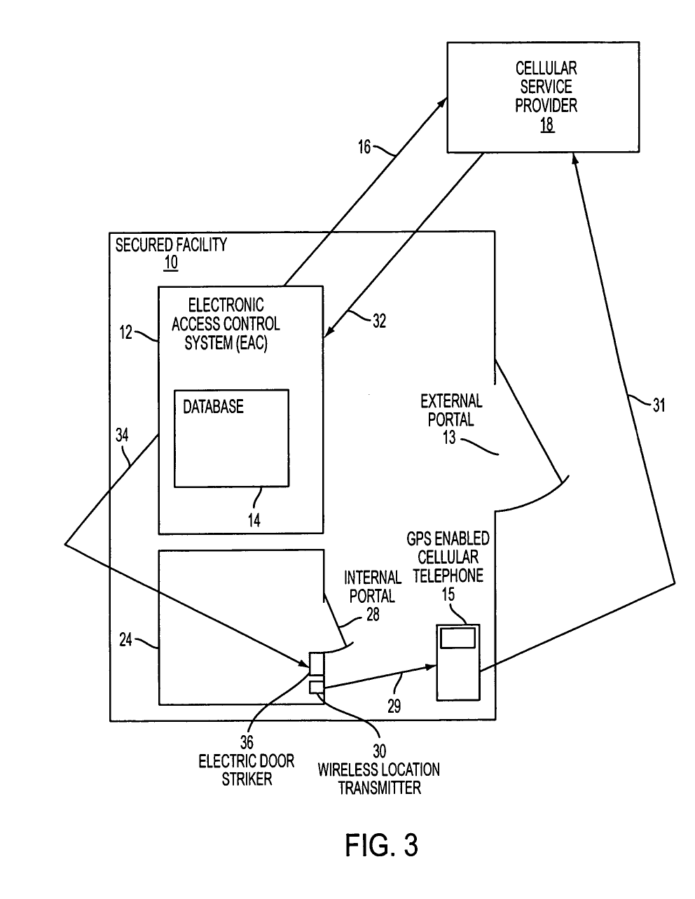

Referring to FIG. 3, another preferred embodiment of both the system and method of the present invention is depicted. A secured facility 10 is shown. Located within the secured facility 10 is an EAC system 12. The EAC system 12 controls access by users to one or more internal rooms 24 through one or more secured internal portals 28.

The EAC system has a database 14 maintained on a computer that contains the identity of one or more users granted access privileges to one or more secured internal portals 28 and the particular secured portals 28 to which a user has been granted access privileges. The database 14 also contains a unique identifier, for example the telephone number, of a cellular telephone 15, adapted as described below, for each user. Again, a user is granted access through a secured internal portal 28 based on the relative geographic positions of the secured internal portal 28 and the user's cellular telephone 15, as described in more detail below.

However, for an secured internal portal 28 it may be more difficult to establish the geographic position of a cellular telephone 15. The GPS signals may be blocked by the facility 10 or maybe so attenuated within the facility 10 that the GPS system cannot be used to establish the geographic position of the cellular telephone 15. In this embodiment, when the cellular telephone 15 is within a configurable radius of a secured internal portal 28, it receives a proximity signal 29 with respect to the second internal portal 28 from a short range wireless radio or cellular transmitter 30. The proximity signal 29 is only broadcast within the configurable radius. The proximity signal 29 and the identifier for the cellular telephone are transmitted 31 by the cellular telephone adapted to do so to a cellular service provider 18. The cellular service provider 18 then automatically transmits periodically 32 to the EAC system 12 the cellular telephone's identifier and the proximity signal 29 from the wireless cellular transmitter 30. In the absence of other geographic positioning information, the proximity signal 29 indicates the geographic position of the cellular telephone 15 to the extent that the cellular telephone 15 is within the configurable radius of the secured internal portal 28. The computer on which the EAC system's database 14 is stored examines the database to determine if the user to which the cellular telephone 15 belongs has been granted access privileges to the secured internal portal 28. When the EAC system 12 has verified the identifier and geographic position, through the proximity signal 29, and the grant of access privileges to the secured internal portal 28, the EAC system 12 then sends a command 34 to an electric door striker 36 that instructs the electric door striker 36 to open the secured internal portal 28.

In addition, another embodiment of the EAC system of the present invention may contain additional security measures to provide an additional level of authentication before the EAC system opens a secured portal. These processes include, but are not limited to, requiring a user to enter a personal identification number (PIN) using his cellular telephone keypad. Referring again to FIG. 3, the PIN is then transmitted to the EAC system 12. The EAC system 12 then checks the PIN against its database 14, which contains information identifying the specific portals to which a PIN has been granted access. Also, the EAC system can use biometric identification information provided by a biometric reader incorporated into a user's cellular telephone 15.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

1. A method for electronic access control to one or more secured portals comprising:
identifying one or more users granted access privileges to one or more secured portals and the secured portals to which each user has been granted access privileges;
identifying a cellular telephone used by each user in seeking access to one or more secured portals;
determining that any cellular telephone is within a configurable radius of any secured portal;
determining that the user of any cellular telephone within a configurable radius of any secured portal has been granted access privileges to the secured portal; and
unlocking the secured portal.

2. The method of claim 1 wherein determining that any cellular telephone is within a configurable radius of any secured portal is done by using a proximity signal with respect to each secured portal.

3. The method of claim 1 wherein determining that any cellular telephone is within a configurable radius of any secured portal is done by using the global positioning satellite system.

4. The method of claim 1 wherein determining that any cellular telephone is within a configurable radius of any secured portal is done by using cellular tower triangulation.

5. A method of electronic access control to one or more secured portals comprising:
identifying one or more users granted access privileges to one or more secured portals and the secured portals to which each user has been granted access privileges;
identifying a cellular telephone used by each user in seeking access to one or more secured portals;
determining a geographic position for each secured portal;
determining a geographic position for each cellular telephone;
determining that the geographic position for any cellular telephone is within a configurable radius of any secured portal;
determining that the user of any cellular telephone within a configurable radius of any secured portal has been granted access privileges to the secured portal; and
unlocking the secured portal.

6. The method of claim 5 wherein determining a geographic position for each cellular telephone is done by using the global positioning satellite system.

7. The method of claim 5 wherein determining a geographic position for each cellular telephone is done by cellular tower triangulation.

8. A method of electronic access control to one or more secured portals comprising:
entering into a database one or more users granted access privileges to one or more secured portals, an identifier for a cellular telephone used by each user in seeking access to one or more secured portals, the secured portals to which each user has been granted access privileges, and a geographic position for each secured portal;
determining a geographic position for each cellular telephone;
determining that the geographic position for any cellular telephone is within a configurable radius of any secured portal;
determining that the user of any cellular telephone within a configurable radius of any secured portal has been granted access privileges to the second portal; and
unlocking the secured portal.

9. An apparatus for electronic access control to one or more secured portals comprising:
a means for identifying one or more users granted access privileges to one or more secured portals and the secured portals to which each user has been granted access privileges;
a means for identifying a cellular telephone used by each user in seeking access to one or more secured portals;
a means for determining that any cellular telephone is within a configurable radius of any secured portal;
a means for determining that the user of any cellular telephone within a configurable radius of any secured portal has been granted access privileges to the secured portal; and
a means for unlocking the secured portal.

10. The apparatus of claim 9 wherein the means for determining that any cellular telephone is within a configurable radius of any secured portal further comprises a proximity signal with respect to each secured portal.

11. The apparatus of claim 9 wherein the means for determining that any cellular telephone is within a configurable radius of any secured portal further comprises the global positioning satellite system.

12. An apparatus for electronic access control to one or more secured portals comprising:
a means for identifying one or more users granted access privileges to one or more secured portals and the secured portals to which each user has been granted access privileges;
a means for identifying a cellular telephone used by each user in seeking access to one or more secured portals;
a means for determining a geographic position for each secured portal;
a means for determining a geographic position for each cellular telephone;
a means for determining that the geographic position for any cellular telephone is within a configurable radius of any secured portal;
a means for determining that the user of any cellular telephone within a configurable radius of any secured portal has been granted access privileges to the secured portal; and
a means for unlocking the secured portal.

13. The apparatus of claim 12 wherein the means for determining a geographic position for each cellular telephone is the geographic positioning satellite system.

14. An apparatus for electronic access control to one or more secured portals comprising:
a database containing one or more users granted access privileges to one or more secured portals, an identifier for a cellular telephone used by each user in seeking access to one or more secured portals, the secured portals to which each user has been granted access privileges, and a geographic position for each secured portal;
a means for determining a geographic position for each cellular telephone;
a means for determining that the geographic position for any cellular telephone is within a configurable radius of any secured portal;
a means for determining that the user of any cellular telephone within a configurable radius of any secured portal has been granted access privileges to the secured portal; and
a means for unlocking the secured portal.
